(19) United States
(12) Patent Application Publication
(10) Pub. No.: US 2025/0349031 A1
(43) Pub. Date: Nov. 13, 2025

(54) Computer system for determining the position of an anchor, and method

(71) Applicant: Hilti Aktiengesellschaft, Schaan (LI)

(72) Inventors: Lukas PFARR, Feldkirch (AT); Mareike ENGEL, Winchester, CA (US); Alona SHAKED, Gamprin-Bendern (LI)

(21) Appl. No.: 18/870,586

(22) PCT Filed: Jun. 12, 2023
(86) PCT No.: PCT/EP2023/065637

§ 371 Date: Nov. 29, 2024

(30) Foreign Application Priority Data
Jun. 27, 2022 (EP) 22181230.8

(51) Int. Cl. G06T 7/73; G06T 7/00; G06T 7/50

(52) U.S. Cl. CPC G06T 7/74; G06T 7/0002; G06T 7/50; G06T 2207/20081; G06T 2207/20084; G06T 2207/20092

(57) ABSTRACT

A computer system for the position determination of an anchor position relative to a construction site object. Via program code, the computer system identifies at least one type of a first anchor, and a camera, to determine a distance between a first anchor position of the first anchor on a construction site object and/or for the first anchor and a position of a second anchor on the construction site object, for a second anchor on the construction site object and/or to an edge of the construction site object, and via an output unit, to output a signal and/or to store a signal in the storage unit, the signal being indicative of whether the distance at least corresponds to a defined target distance. A method is also provided. The invention facilitates proper setting of the first anchor and also checking as to whether the first anchor has been properly set.

The invention relates to an apparatus for assisting the setting of an anchor, for example a screw or a nail.

### BACKGROUND

For safety reasons, set anchors have to satisfy specific minimum requirements.

By way of example, the set anchor has to comply with specific minimum distances to other, adjacent anchors and/or to edges of construction site objects into which the anchor is intended to be set. Otherwise there is the threat of safety risks, for example due to the fact that the set anchor cannot manifest the holding forces required for a specific application with sufficient safety.

Attempts have been made hitherto to check compliance with these minimum requirements manually, in particular by means of measurement using a length measuring device.

### SUMMARY OF THE INVENTION

However, this often proves to be very difficult in customary construction site situations, for example in overhead work, in work at great heights or the like.

One particular difficulty also consists in the fact that height differences between measurement points lead to measurement errors on account of viewing that is not completely perpendicular to the length measuring device, and the associated parallax.

However, measurement accuracies of below one centimeter, in particular of less than 0.5 cm, are generally required for checking this minimum requirement.

It is an object of the present invention to provide an apparatus which enables an anchor to be securely set into a construction site object. It is furthermore desirable if the apparatus can be used to check in a simple manner whether an anchor already set has been set properly.

The present invention provides a computer system for the position determination of an anchor position relative to a construction site object, for example a concrete element, comprising at least one camera, at least one output unit, at least one storage unit, and at least one microprocessor, program code for execution on the microprocessor being stored in the storage unit, the program code being configured to identify at least one type of a first anchor, and by means of the camera, to determine at least one distance between a first anchor position of the first anchor on a construction site object and/or for the first anchor and a position of a second anchor on the construction site object, for a second anchor on the construction site object and/or to an edge of the construction site object, and by means of the output unit, to output a signal and/or to store a signal in the storage unit, the signal being indicative of whether the distance at least corresponds to a defined target distance.

The computer system can thus identify the type of the anchor and, on the basis of the type of the anchor, utilize data linked with this type, in particular data regarding the geometry of the anchor. One or more recordings can be recorded by the camera. The program code can be configured to evaluate the one or more recordings.

In particular, the program code can be configured to determine the distance by means of image processing. In this case, the accuracy of the image processing, in particular of the distance determination, can be improved by the data linked with the type of the anchor being taken into account in the image processing. If the anchor is a screw anchor having a head, for example, then a known diameter of the head can serve for ascertaining an imaging scale in the recordings.

If a plurality of recordings are recorded, in particular from different perspectives, then the parallax offset that arises can be used to generate depth information from the recordings.

If at least one moving image sequence is recorded, then different depths of the respective image contents can be deduced from the moving image sequence, in particular from parts of the recordings that move at different speeds relative to the overall image.

Alternatively or additionally, it is also conceivable for the camera to have a depth sensor. The camera can have one or more time-of-flight-based depth sensors, for example. Depth information necessary for the evaluation can then also be obtained directly from the recordings.

Depth information can simplify and/or improve the accuracy of the image processing described here. However, it is also conceivable for the camera to be configured to record only a two-dimensional recording.

The camera can be and/or comprise a color image camera, a black-and-white camera and/or an event camera.

The determined distance can be output as a signal on the output unit. A user of the computer system can thereby be informed as to whether or not the set anchor has been set properly.

If the first anchor has not been set properly, provision can be made for the first anchor subsequently to be corrected in terms of its fit and/or to be removed. In the case of removal, provision can be made for an exchange anchor to be set at the first anchor position instead of the first anchor. The exchange anchor can then also be checked in regard to its proper fit.

Alternatively or additionally, it is also conceivable for a position at which the anchor is not yet intended to be set to be determined as the anchor position. The anchor position can correspond for example to the position of a borehole, in particular one that is yet to be made.

The user can then be informed as to whether the position of the borehole or the anchor position actually enables the anchor to be set correctly, or whether for example a further borehole should be drilled at a different, better suited, position.

In other words, the computer system can be used for quality assurance of an anchor already set and/or for rapidly finding suitable anchor positions.

The first anchor and/or further anchors can be for example screw anchors, bolt anchors, impact anchors, in particular nails, or the like. They can be configured for setting into specific materials, in particular rocks, for example concrete, metals and/or wood. By way of example, the first anchor can be a concrete screw anchor. Preferably, the construction site object can accordingly then also be and/or comprise an object comprising concrete, for example a reinforced concrete object.

The computer system can be portable. For this purpose, it can have a weight of less than one kilogram, for example less than 0.5 kilograms. It can be designed for example as a portable telecommunication device, for example in the form of a so-called smartphone.

The output unit can comprise a display unit. It can also comprise an input unit. By way of example, the output unit can comprise a touchscreen.

The computer system can be a multipartite computer system, in particular comprising a local computer unit and a remote computer unit. By way of example, it can be and/or comprise a cloud-based computer system.

The microprocessor can have one or more computing units. It is conceivable, for example, for one of the computing units to be a linearly operating computing unit. At least one further computing unit can be a computing unit designed for parallel processing. Such a computing unit can be a graphics processor or be designed as part of a graphics processor, for example.

The microprocessor and/or the program code can be designed to comprise and/or to form at least one machine learner. The machine learner can comprise a trainable neural network. The neural network can be convolution-based.

The type of the first anchor can be identified by recognition of a data matrix code, for example a QR code. The latter can preferably be arranged and/or formed on the first anchor, or at least on packaging from which the first anchor is removed. Alternatively or additionally, it is also conceivable for a user of the computer system to input the type of the first anchor manually into the computer system in order to identify the type in this way.

It is also conceivable for the program code to be configured to identify the type of the first anchor on the basis of at least one structural feature of the anchor. The structural feature can be related to the geometry of the anchor, for example. That can involve for example a dimension of the first anchor. Precisely in the case of anchors, for example screw anchors, an unambiguous type assignment often cannot be carried out solely on the basis of such geometric features. By way of example, many types of different anchors, in particular anchors having different total lengths, have the same head diameter, since the head shape and the head diameter are intended to conform to specific standardizations. Therefore, it is alternatively or additionally conceivable for the program code to be configured to evaluate at least one of the recorded images with regard to the presence of lettering, for example a type designation. It is also conceivable for the type of the first anchor to be identifiable on the basis of surface features which, on account of a specific method for producing the first anchor, arise from this method as uniquely as possible and in a manner as specific as possible to the type of the first anchors. Such surface features can be and/or comprise for example specific scored tracks and/or engravings, for example in the head of the first anchor. It is then conceivable for the program code to be configured to evaluate the at least one recording with regard to the presence of such specific surface features.

The accuracy of the measurement by means of such image processing can be increased further by the program code being configured to use data linked with the type of the respective anchor for calibration of length measurements. If the head diameter of the first anchor is known, for example, then after the identification of the head of the first anchor in a recording recorded by the camera, this length can be used for calibration or consulted at least for calibration.

It is conceivable for the program code to be configured to define the target distance depending on the type of the first anchor and/or the type of the second anchor. For this purpose, it is possible to have recourse to data associated with the type of the first anchor. The target distance can correspond example to a distance between the first anchor and a second anchor. Alternatively or additionally, the target distance can correspond to a distance between the first anchor and an edge of the construction site object.

The computer system can have a communication module for communication with a remote computer system. The program code can be configured to retrieve data, in particular regarding the type of the first anchor, from the remote computer system via the communication module. In particular, the program code can be configured to retrieve the target distance.

It is also conceivable for planning data to be stored in the storage unit. The planning data can comprise data such as the target distance, for example. The data can also comprise material properties, geometries, in particular target geometries, in particular of the construction site object, of an intermediate object and/or of the first and/or further anchors. The program code can be configured to load the planning data into the storage unit from the remote computer system by means of the communication module.

The program code can also be configured to determine at least one material property of the construction site object. Depending on the determined material property, for example a type of material, the presence of cracks and/or other damage in particular of the construction site object, the target distance can then be adapted and/or defined.

Anchors are often used to secure further objects to the construction site object. Setting properties of the first anchor can then depend on the type of the further object(s). By way of example, a maximum possible setting depth of the first anchor can depend on the thickness of an object to be secured. It is therefore expedient if the program code is configured to identify at least one intermediate object which is to be arranged and/or has been arranged at the anchor and at the construction site object. The intermediate object can be for example a washer, a base plate and/or the like.

The program code can be configured to determine a setting depth of the first anchor in the construction site object by means of the camera.

By way of example, the program code can be configured to determine the setting depth by means of image processing of a recording from the camera. A projection of the first anchor from the construction site object can be determined for this purpose. If the total length of the first anchor is known, said setting depth can be deduced from the total length minus the projection.

The computer system can be used for quality assurance. It is therefore expedient if the program code is configured to determine the distance when the first anchor has already been set. In this case, therefore, the program code is configured to identify an anchor already set and to check at least one minimum requirement, for example the target distance, for example of the first anchor from the edge of the construction site object.

Alternatively or additionally, the program code can be configured to determine the distance proceeding from the first anchor position when the first anchor has not been set. In particular, the program code can then be configured, by means of image processing of at least one recording from the camera, to identify for example a borehole or a comparable anchor position at which the first anchor is intended to be set. It is conceivable, in particular, for a user of the computer system to mark an anchor position on the construction site object by means of a pointing device, for example a laser pointer. An anchor position marked in this way can then be identified by the program code or by the computer system and can be processed analogously to the description given above.

This makes it possible to use the computer system for rapidly finding suitable anchor positions. The computer system can thus be usable as a mounting aid.

It is furthermore conceivable for the program code to be configured to determine a surface profile of the construction site object and/or of the intermediate object using at least one input by a user of the computer system that characterizes the construction site object and/or the intermediate object. In particular, the program code can furthermore be configured to request an input of at least three positions, in particular by way of graphical representation and selection with the aid of the output unit, in particular if the output unit also comprises an input unit, for example in the form of a touchscreen.

The program code can furthermore be configured to record at least one recording of the construction site object including the first anchor, the first anchor position, the second anchor and/or the second anchor position by means of the camera.

The recording can be represented, in particular graphically, on the output unit.

If the output unit has a touchscreen, the program code can then be configured to request for example at least three input positions from the user.

The input positions can be provided by the user for example by tapping on the corresponding positions on the touchscreen.

Assuming that the three input positions belong to the same element, the accuracy with which the construction site object and/or the intermediate object can be identified can thus be improved further.

It is also conceivable for the recognition of edges of the construction site object and/or of the intermediate object to be able to be improved by means of such input positions.

The invention also relates to a handheld power tool comprising a computer system of the type described above and/or below.

The handheld power tool can be a setting device. By way of example, it can be a bolt setting device. Alternatively, it is also conceivable for the handheld power tool to be a screw setting device, for example a cordless screwdriver and/or a cordless impact wrench.

It can be configured to verify the correct fit, in particular a correct position, of a set securing element, for example of a screw or nail. The handheld power tool can thus be configured in particular for quality assurance of the set securing element.

Alternatively or additionally, it is also conceivable for the handheld power tool to comprise a drill. The drill can be a hammer drill. It can be configured in particular for processing rock, for example concrete. The handheld power tool can thus be configured to check an anchor position, in particular the position of a borehole, and/or to signal to a user of the handheld power tool whether a planned position complies or would comply with given requirements.

Consequently, the handheld power tool can be configured, before the beginning of the drilling of a borehole in the case of the drill or before the beginning of the setting of a securing element in the case of the setting device, to signal to the user an enable signal if the handheld power tool, in particular a tooltip of a tool arranged on the handheld power tool, is heading for a position that complies with the requirements, and/or to signal to the user a disable signal if the handheld power tool, in particular the tooltip, is heading for a position that does not comply with the requirements. Instead of or in addition to the signaling of the enable signal and/or the disable signal, a work process, for example drilling of a borehole or setting of the securing element, can also be startable and/or disabled.

The arrangement of the computer system on the handheld power tool makes it possible for the user of the handheld power tool to check an anchor position or a position of an anchor without having to put down the handheld power tool. Consequently, for example, the user does not need firstly to put down the handheld power tool, to take hold of a smartphone or the like having the computer system, to use the computer system and then to change back once again to the handheld power tool. Work sequences can thus be considerably simplified and accelerated. Moreover, such simplification and acceleration make it possible to improve the willingness of the user also actually to perform for example documentation tasks for documenting for example a correct fit of a set anchor.

The computer system can be arranged releasably at a securing point of the handheld power tool. It is conceivable, in particular, for the securing point to correspond to a battery interface, in particular if the handheld power tool is capable of cordless operation. The computer system can then be secured to the battery interface.

The computer system can also have a battery interface for this purpose.

The scope of the invention furthermore includes a method for assisting the setting of a first anchor into a construction site object and/or for quality control of a first anchor which has been set into a construction site object, wherein with a computer system of the type described above and/or below, by means of a camera of the computer system, at least one distance between a first anchor position of the first anchor on a construction site object and/or for the first anchor and a position of a second anchor on the construction site object, for a second anchor on the construction site object and/or to an edge of the construction site object is determined, and wherein the determined distance is compared with a target distance.

Further features and advantages of the invention are apparent from the detailed description of exemplary embodiments of the invention that follows, with reference to the figures of the drawing which shows details essential to the invention, and from the claims. The features shown therein should not necessarily be considered to be true to scale and are illustrated in such a manner that the special features according to the invention can be clearly visualized. The various features can each be implemented individually in their own right or collectively in any combinations in variants of the invention.

### BRIEF DESCRIPTION OF THE DRAWINGS

Exemplary embodiments of the invention are illustrated in the schematic drawing and elucidated in detail in the description that follows.

In the figures:

FIG. 1 shows a construction site situation with a construction site object and a computer system;

FIG. 2 shows a cross-section through the construction site object with a first anchor set therein;

FIG. 3 shows a machine learner;

FIG. 4 shows a method;

FIG. 5 shows an excerpt from a screenshot of a result output of the computer system; and

FIG. 6 shows a handheld power tool with a computer system.

### DETAILED DESCRIPTION

In the description of the figures that follows, comprehension of the invention is facilitated by use of the same reference signs in each case for identical or functionally corresponding elements.

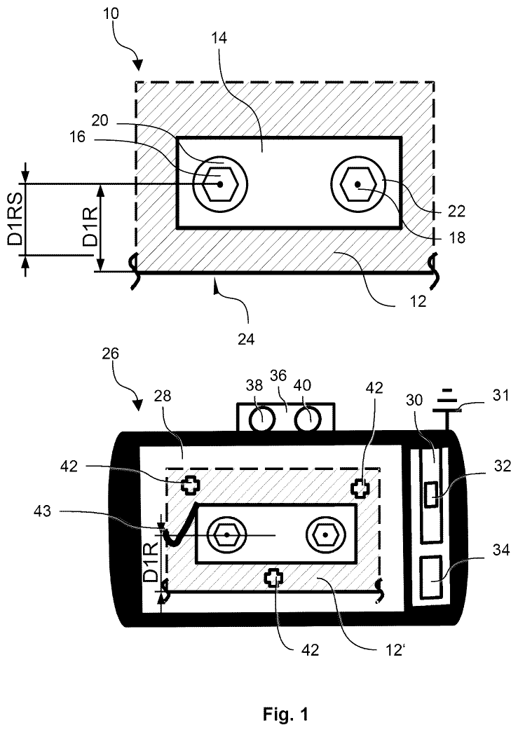

FIG. 1 shows a construction site situation 10. This can involve a building construction site, for example. In particular a construction site object 12, in this case a concrete element, is discernible. The concrete element can correspond for example to a base slab of a floor or a ceiling. A base plate 14 is mounted on the construction site object 12 by means of a first anchor 16 and a second anchor 18. The first anchor 16 and the second anchor 18 are each set into the construction site object 12 and through the base plate 14 via a first washer 20 and a second washer 22, respectively.

The first anchor 16 and the second anchor 18 are concrete screw anchors.

The construction site object 12 has an edge 24.

A computer system 26 is intended to be used, then, to check whether the first anchor 16 has been set properly. By way of example, the intention is, in particular, to check whether an edge distance D1R between the first anchor 16 and the edge 24 attains at least a target distance D1RS.

The computer system 26 has an output unit 28. The output unit 28 has a touchscreen. On said output unit, graphical information can thus be output; moreover, positions or the like can be input by means of tapping.

Positions can be input by a user two-dimensionally by means of tapping the touchscreen at a location corresponding to the position to be input. Alternatively or additionally, it is conceivable for the user, in order to input the position, to point at a corresponding location in space and/or to make a gesture corresponding to the position. The indicated position and/or the gesture can then be recorded and evaluated in order to determine the position.

Furthermore, the computer system 26 has a storage unit 30. A program code 32 is stored in the storage unit 30. The program code 32 can be executed on a microprocessor 34 of the computer system 26.

The computer system 26 has a communication module 31 configured for establishing a data connection to a remote computer system.

Furthermore, the computer system 26 has a camera 36. The camera 36 is designed as a stereoscopic camera. For this purpose, it has two recording units 38, 40. The recording units 38, 40 are arranged at a distance from one another on the computer system 26.

They can thus record recordings from different perspectives. In this case, the camera 36 overall is configured to record recordings having depth information, i.e. three-dimensional recordings of an environment, from individual recordings by the recording units 38, 40.

The recording units 38, 40 can each be configured to record color recordings.

FIG. 1 illustrates by way of example that the output unit 28 shows an image representation 12′ of the construction site object 12. Furthermore, three input positions 42 are discernible. These three input positions 42 correspond to inputs of positions of a user (not illustrated in FIG. 1) which the user assigns to the construction site object 12 or the image representation 12′ thereof. An input position 42 can be input by the user touching the output unit 28 designed as a touchscreen at the corresponding location.

The computer system 26, in particular the program code 32 in conjunction with the microprocessor 34, is configured to evaluate recordings, in particular moving image sequences, recorded by the camera 36. By way of example, types of the first anchor 16 and/or of the second anchor 18 are identified and the course of the edge 24 is determined. Furthermore, the positions associated with the first anchor 16, the second anchor 18 and the age 24 are determined. Alternatively or additionally, at least one type, for example the type of the first anchor 16, can also be capable of being input manually. It is also conceivable that a barcode, data matrix code or the like that determines the type can be scanned in for the determination.

On the basis of the determined and/or input type of the first anchor 16, a value of the target distance D1RS for this type is ascertained via the communication unit 31.

The distance D1R is then determined from the determined positions for example of the first anchor 16 and the course of the edge 24.

The distance D1R is compared with the value of the target distance D1RS. In the case illustrated in FIG. 1, the target distance D1RS is complied with, and so the computer system 26 outputs a positive check signal 43 on the output unit 28.

It goes without saying that minimum requirements other than the target distance D1RS, for example also minimum requirements in respect of the second anchor 18, can also be checked by means of the computer system 26 in an analogous manner.

As explained above, the program code 32 is configured, inter alia, to evaluate recordings from the camera 36 by means of image processing.

In order to carry out these image processings, a machine learner is formed by the program code 32 in conjunction with the storage unit 30 and the microprocessor 34.

One example of a different minimum requirement is a minimum setting depth with which the first anchor 16 must project into the construction site object 12.

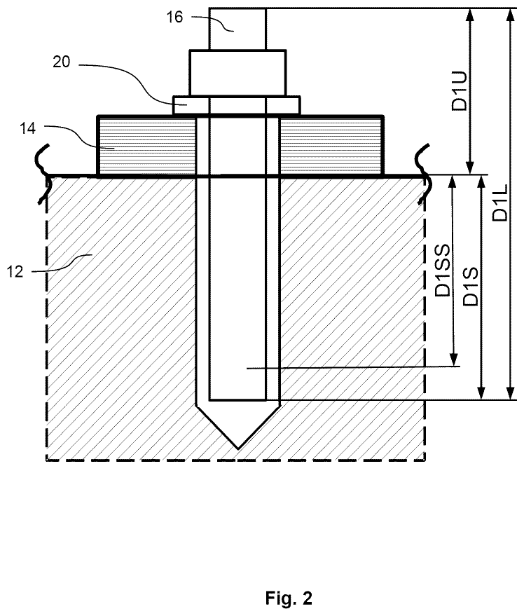

In this respect, FIG. 2 shows a partially sectional view through the construction site object 12 with the first anchor 16 and the intervening base plate 14 and also the first washer 20.

The first anchor 16 projects from the construction site object 12 with a projection D1U. The first anchor 16, according to its type, has overall a length D1L. It thus projects into the construction site object 12 with a setting depth D1S corresponding to the difference between D1L and D1U.

In order to ascertain the setting depth D1S, the program code 32 (FIG. 1) is therefore configured to deduce the setting depth D1S from the projection D1U by means of image processing from recordings from the camera 36 (see FIG. 1). The program code 32 is furthermore configured to compare the ascertained setting depth D1S with a minimum setting depth D1SS and to check whether the minimum setting depth D1SS is at least attained. In the example in accordance with FIG. 2, this condition is met; therefore, the program code 32 can in turn output a positive check signal 43 (see FIG. 1) upon execution by means of the output unit 28. Otherwise, the program code would initiate the outputting of a negative check signal, for example an error signal, in order to signal to the user an improper fit of the first anchor 16.

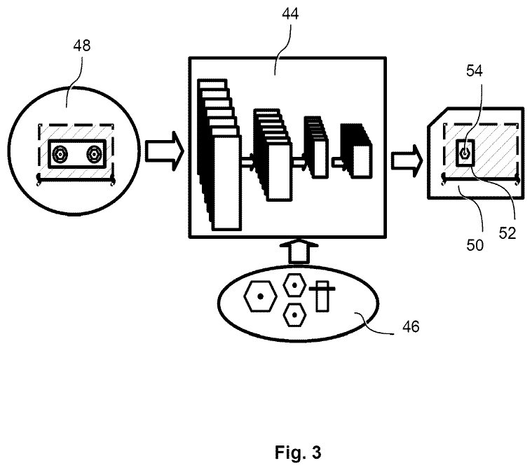

FIG. 3 schematically shows a machine learner 44 and also by way of example possible training data 46 for training the machine learner 44, possible input data 48 for carrying out at least one of the image processings, and also an example of possible output data 50 of the machine learner 44.

The machine learner 44 can comprise at least one convolution-based neural network, for example a so-called “convolutional neural network”, referred to hereinafter as CNN, having a plurality of, for example 4 or 5, processing layers. The neural network can be configured to take into account, as training data, rule data sets as well as image data.

The machine learner 44 can be trained to semantically segment recordings of construction site objects. The semantic segmentation can concomitantly comprise an assignment of a bounding box and/or a reference point to a recognized object.

In particular, the machine learner 44 can be trained to identify construction site objects, for example concrete elements, intermediate objects, for example base plates, washers and/or different types of anchors.

By way of example, depending on the type of an anchor, 50 to 150 different views provided with annotations, in particular under different lighting and/or contrast conditions and from different perspectives, preferably also comprising partial views of the anchor and/or views from above, or obliquely from above, of a head or a free end of the anchor, can be provided as a basis for the training data. In order to further improve the recognition rates, the training data can be extended by image rotations, brightness modifications and/or contrast modifications.

Analogously, training data can be compiled and optionally extended also for the further objects or object classes which are to be identified.

The machine learner 44 can additionally be trained also to identify other everyday articles and articles which typically appear on construction sites, but which cannot be associated with the objects to be recognized, for example tools or power tools, as articles to be excluded from the further image processing. For this purpose, general image databases for everyday articles can also be used for such supplementary training.

The training of the machine learner 44 can be effected by supervised learning.

In the specific configurations that might be expected from construction site situations 10 to be examined, there are furthermore certain rules.

For example, it can be assumed that the first washer 20 is arranged between the head of the first anchor 16 and the base plate 14 or the construction site object 12. It is possible for example to rule out the washer 20 being situated outside the first anchor 16. Moreover, it can be assumed that the base plate 14 is arranged between the construction site object 12 and the head of the first anchor 16, whereas the construction site object 12 cannot be situated between the base plate 14 and the head of the first anchor 16.

A further rule arises if input positions concerning a specific construction site object are requested from the user. By way of example, if at least three input positions are in each case requested from the user, each of said input positions relating to a fundamentally planar object, for example the construction site object 12 or the base plate 14, then further rules arise owing to the fact that the positions associated with the input positions must be situated on the same object, that the object must belong to the object respectively requested and—if depth information is available—that the requested object must lie in the plane spanned by the input positions.

The training data 46 can therefore also comprise such rules. Furthermore, the machine learner 44 can be configured to take account of such rules.

After training has taken place, the machine learner 44 can obtain at least one recording, preferably a plurality of recordings, from the camera 36 as input data 48. The output data 50 resulting from the processing in the machine learner 44 can then comprise indications concerning identified objects and/or bounding boxes 52 and/or reference points 54 to the identified objects. For reasons of simplification, only one bounding box 52 and one reference point 54 are provided with a reference sign in FIG. 3.

The program code 32 can then be configured, after identification of the first anchor 16 and the edge 24 of the construction site object 12 and also the associated reference points 54, to calculate the distances required for the respective checking, for example the edge distance D1R (see FIG. 1), and to compare same with the assigned target distance D1RS (see FIG. 1). Depending on the outcome of the comparison, the program code 32 can then store a signal in the storage unit 30 and/or output a signal via the output unit 28.

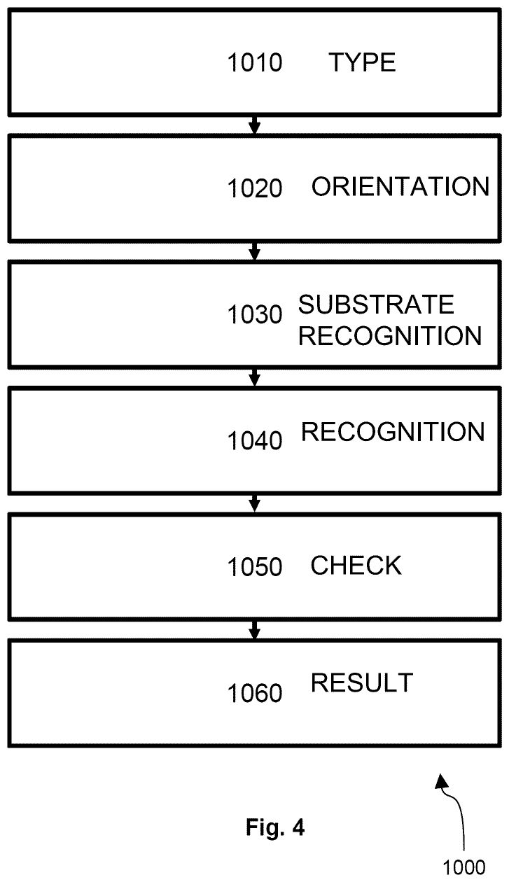

FIG. 4 shows a method 1000 that can be realized by the program code 32 in conjunction with the further elements of the computer system 26. In particular, the program code 32 can be configured to carry out the method 1000.

The method 1000 is explained in greater detail below using the reference signs introduced hereinabove for the elements of the computer system 26 and also the construction site situation 10. In variants of the method 1000, one or more of the phases described below can be simplified or omitted.

It is assumed that the machine learner 44 has already been trained

In a type identification phase 1010, types of anchors to be checked are ascertained. For this purpose, for example, associated data matrix codes of packagings of the relevant anchor types can be scanned by means of the camera. Minimum requirements to be fulfilled by the anchors, for example the target distance D1RS between the first anchor 15 and the edge 24, are loaded into the storage unit 30 from a remote computer system, in particular a suitably populated database system, by means of the communication module 31.

In an orientation phase 1020, the camera records recordings in the form of moving images of the construction site object 12. From the motion information contained therein, the program code 32 derives a foreground/background differentiation. In particular, a reference plane including a point of origin associated with the reference plane is ascertained or defined as a referential plane to which three-dimensional positions of subsequently identified objects are referenced.

In a substrate recognition phase 1030, one of the recordings is represented on the output unit 28. At least three input positions 42 are requested from a user of the computer unit 26, which input positions are situated on the construction site object 12 and are thus intended to characterize the construction site object 12. Using these input positions 42, the machine learner 44 ascertains the presence of the construction site object 12 and in particular the location of the edge 24 thereof.

In a recognition phase 1040, by means of the machine learner 44 and using the input positions 42, further objects, in particular the base plate 14 and set anchors, in particular the first anchor 16 and the second anchor 18, are identified and associated referential boxes 52 and reference points 54 are determined. In this case, the positions and orientations of the referential boxes 52 and of the reference points 54 are ascertained three-dimensionally with reference to the reference plane ascertained in the orientation phase 1020 and the point of origin of said reference plane.

In a checking phase 1050, distances between the identified anchors 16, 18 and between the latter and the edge 24, including example the edge distance D1R between the first anchor 16 and the edge 24, are calculated using the reference points 54, and optionally the referential boxes 52. These distances are subsequently compared with minimum requirements present in the storage unit 30. By way of example, the edge distance D1R is compared with the target distance D1RS.

In a result phase 1060, depending on the outcome of the comparison, positive or negative check signals are then represented on the output unit 28.

It is conceivable for the positive or negative check signals additionally to be stored retrievably in a documentation system, such that they can be made available again for later checking purposes, for example. The documentation system can be located on a remote computer system and can be reachable via the communication module 31, for example.

It is furthermore conceivable for the fit of the relevant anchor to be corrected in the case of a negative check signal.

This variant of the method 1000 thus enables quality control of the first anchor 16 that has already been set, for example.

A variant of the method 1000 can also enable prior checking of an anchor position. Unless described otherwise hereinafter, this variant can also comprise one or more of the above-described phases of the method 1000.

The anchor position to be checked can be defined by way of a marking on the base plate 14. It is also conceivable for the anchor position that is to be checked to correspond to a position of a borehole or the like.

It is thus necessary to check whether an anchor of a specific type is able to be set properly at the anchor position to be checked, in particular whether minimum requirements to be made of the type of the anchor would be met if the anchor were set at the anchor position to be checked.

Preferably, for this purpose, the type of the anchor to be set at the anchor position to be checked is determined during the type identification phase 1010 by the scanning of a data matrix code or a barcode and/or by manual input.

In this variant, the recognition phase 1040 is modified to the effect that the anchor position to be checked together with a reference point 54 assigned thereto and/or a referential box 52 and the associated positions are ascertained instead of the first anchor 16 or instead of a set anchor. By way of example, recognition of the marking or the borehole can be effected for this purpose.

In this variant, the checking phase 1050 is modified to the effect that the corresponding anchor position to be checked replaces the first anchor 16 or identified anchors. In this regard, for example, the edge distance D1R between the anchor position to be checked and the edge 24 can be calculated.

In the result phase 1060, it is conceivable for the outcome of the comparison to be represented once again on the output unit 28 by means of corresponding check signals. Alternatively or additionally, it is also conceivable for setting of the first anchor 16 to be made possible or blocked depending on the outcome of the comparison. By way of example, in the case of a negative outcome, a handheld power tool that should be used to make a borehole on the marking can be stopped and/or disabled. Alternatively or additionally, a sitting device for setting the first anchor 16 can be stopped and/or disabled in this case.

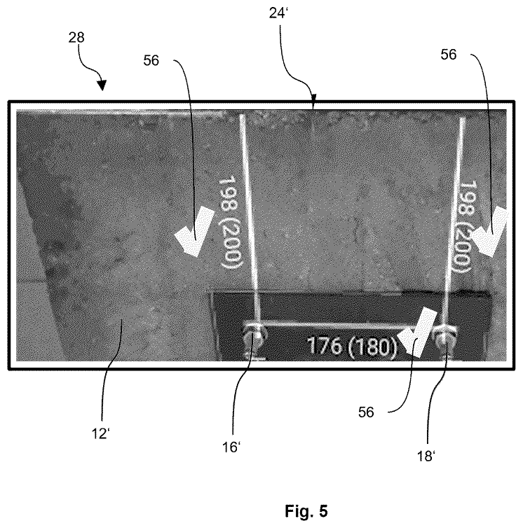

FIG. 5 shows an excerpt from such an output on the output unit 28 on the basis of an output of a demonstrator system of the computer system 26.

In particular, image representations 12′, 16′, 18′ and 24′ of the construction site object 12, of the first anchor 16, of the second anchor 18 and also of the edge 24 are discernible.

Ascertained distances (in millimeters) are likewise discernible as numerical values. In the case of the demonstrator system used to create the output, the actual distances were likewise known in order to be able to check resulting measurement errors. In FIG. 5, the actual distances are indicated as numerical values between parentheses, likewise in millimeters.

It was thus possible to ascertain distances with measurement errors of less than 0.5 centimeter, in particular of 2 mm, corresponding to the difference between 200 mm and 198 mm, and of 4 mm, corresponding to the difference between 180 mm and 176 mm.

Check signals 56 associated with the distances are furthermore depicted, which each correspond to positive check signals in this case. The check signals 56 thus indicate that the anchors 16 and 18 have been set properly.

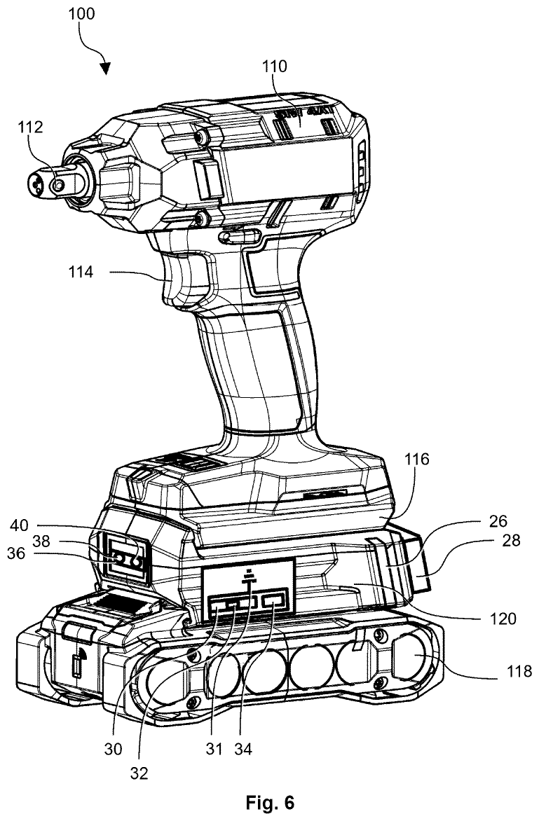

FIG. 6 shows a handheld power tool 100. The handheld power tool 100 is designed as a screw setting device, in particular as a rechargeable-battery-powered impact wrench.

It has a tool body 110 with a tool fitting 112 for receiving a screwing tool. The handheld power tool 100 is configured to drive the tool fitting 112 in a rotating and/or striking manner when a actuation button 114 is actuated. For this purpose, the handheld power tool 100 has a motor arranged in the tool body 110.

A securing point 116 is formed on an underside of the tool body 110. The securing point 116 enables releasable securing of a rechargeable battery 118 to the tool body 110. The securing point 116 can have a latching mechanism.

The securing point 116 furthermore has an electrical interface, via which electrical energy is able to be transferred to the motor. In addition, the securing point, in particular its electrical interface, 116 can be configured for data transfer.

In the application shown in FIG. 6, a computer system 26 is arranged at the securing point 116.

In terms of its set-up and with regard to its functionalities, the computer system 26 can correspond to the computer systems 26 described above, unless described otherwise hereinafter.

In particular, the computer system 26 is configured for implementing at least one of the variants of the method 1000 (see FIG. 4).

For this purpose, it has once again the storage unit 30, in which the program code 32 is stored. The program code 32 can be executed on the microprocessor 34 of the computer system 26.

The computer system 26 also has the communication module 31, inter alia, which once again is configured for establishing a data connection to a remote computer system.

In FIG. 6, for illustration reasons, the elements 30, 31, 32, 34 are only illustrated highly schematically, but are preferably situated within a housing 120 of the computer system 26.

Furthermore, the computer system 26 once again has the camera 36 having the two recording units 38, 40.

For input and output, the computer system 26 furthermore has an output unit 28 on a rear side, said output unit comprising a, more particularly glove-operable, touchscreen. Consequently, manual inputs, for example of an anchor type, can also be effected via the output unit 28.

A special feature of this computer system 26 is that on its top side it has a fitting shape designed complementarily to the securing point 116, such that it can be pushed onto the securing point 116, as depicted in FIG. 6.

On its underside it has a shape corresponding to the securing point 116, such that the rechargeable battery 118, at this underside, is securable releasably and has also been secured releasably in accordance with the illustration in FIG. 6.

In this respect, the computer system 26 in this embodiment forms an intermediate module for arrangement between the rechargeable battery 118 and the tool body 110. Preferably, the electrical interface of the securing point 116 is looped through from the underside of the computer system 26 to the top side thereof.

It is conceivable for this embodiment of the computer system 26 also to be usable independently of the tool body 110, for example together with the rechargeable battery 118.

It is also conceivable for at least one of the elements 30, 31, 32 or 34 to be arranged and/or formed outside the housing 120, in particular as part of the tool body 110. By way of example, it is conceivable for the microprocessor 34 to be designed as a microprocessor that is used jointly or at least usable jointly by the computer system 26 and also the tool body 110.

Consequently, in this embodiment, too, the computer system 26 is configured for assisting the setting of anchors into a construction site object, in particular for drilling a borehole at a specific anchor position, and/or for quality control of an anchor which has been set into a construction site object.

1-12. (canceled)

13. A computer system for the position determination of an anchor position relative to a construction site object, the system comprising:
at least one camera;
at least one output unit;
at least one storage unit; and
at least one microprocessor, program code for execution on the microprocessor being stored in the storage unit, the program code being configured
to identify at least one type of a first anchor, and
via the camera, to determine at least one distance between a first anchor position of the first anchor on the construction site object or for the first anchor and a position of a second anchor on the construction site object, for the second anchor on the construction site object or to an edge of the construction site object, and
via the output unit, to output a signal or to store a signal in the storage unit, the signal being indicative of whether the distance at least corresponds to a defined target distance.

14. The computer system as recited in claim 13 wherein the target distance depends on the type of the first anchor.

15. The computer system as recited in claim 13 further comprising a communication module for communication with a remote computer system, the program code being configured to retrieve the target distance from the remote computer system via the communication module.

16. The computer system as recited in claim 13 wherein the program code is configured to determine at least one material property of the construction site object.

17. The computer system as recited in claim 13 wherein the program code is configured to identify at least one intermediate object which is to be arranged or has been arranged at the first anchor and at the construction site object.

18. The computer system as recited in claim 17 wherein the intermediate object is a base plate or a first washer.

19. The computer system as recited in claim 13 wherein the program code is configured to determine a setting depth of the first anchor in the construction site object via the camera.

20. The computer system as recited in claim 13 wherein the program code is configured to determine the distance when the first anchor has already been set.

21. The computer system as recited in claim 13 wherein the program code is configured to determine the distance proceeding from the first anchor position when the first anchor has not been set.

22. The computer system as recited in claim 13 wherein the program code is configured to determine a surface profile of the construction site object or of the intermediate object using at least one input by a user of the computer system that characterizes the construction site object or the intermediate object.

23. The computer system as recited in claim 13 wherein the first anchor is a screw anchor, a bolt anchor, an impact anchor or a nail.

24. The computer system as recited in claim 13 wherein the construction site object is a concrete element.

25. A handheld power tool comprising the computer system as recited in claim 13.

26. A setting device or a drill comprising the computer system as recited in claim 13.

27. The handheld power tool recited in claim 25 wherein the computer system is arranged releasably at a securing point of the handheld power tool.

28. A method for assisting the setting of a first anchor into a construction site object or for quality control of a first anchor set into a construction site object, the method comprising:
with the computer system as recited in claim 13 via the camera of the computer system, at least one distance between a first anchor position of the first anchor on the construction site object or for the first anchor and a position of a second anchor on the construction site object, for the second anchor on the construction site object or to an edge of the construction site object is determined, and wherein the determined distance is compared with a target distance.
